(19) United States
(12) Patent Application Publication
(10) Pub. No.: US 2023/0294343 A1
(43) Pub. Date: Sep. 21, 2023

(54) A MOLD FOR INJECTION MOLDING

(71) Applicant: LEGO A/S, Billund (DK)

(72) Inventor: Mads DIEMER, Billund (DK)

(21) Appl. No.: 18/006,775

(22) PCT Filed: Jul. 28, 2021
(86) PCT No.: PCT/EP2021/071093

§ 371 Date: Jan. 25, 2023

(30) Foreign Application Priority Data
Jul. 30, 2020 (DK) 202070504

(51) Int. Cl. B29C 45/27

(52) U.S. Cl. CPC B29C 45/2711

(57) ABSTRACT

A mold for an injection molding tool. The mold has a pin gate extending between a gate inlet and a gate opening. The pin gate forms a tapered, cylindrical channel through a body of the mold and abruptly transitions to a smooth funnel. The gate opening is positioned at an end of the funnel. The pin gate is configured to receive molding material from a runner channel of the injection molding tool at the gate inlet and dispense the molding material at the gate opening. The mold also has a mold cavity in fluid connection with the gate opening of the pin gate and configured to receive the molding material therefrom.

### CROSS-REFERENCE TO RELATED APPLICATIONS

The present application is a U.S. National Stage Application of International Application No. PCT/EP2021/071093, filed on Jul. 28, 2021 and published on Feb. 3, 2022 as WO 2022/023395 A1, which claims the benefit and priority of Danish Patent Application No. 202070504, filed on Jul. 30, 2020, each of which is incorporated herein by reference in its entirety for any purpose whatsoever.

### FIELD OF THE DISCLOSURE

The present disclosure relates to a mold adapted for an injection-molding tool, the mold comprises a main body having one side forming a mold cavity, the mold further comprises a gate having a first end with an opening arranged for being connected to a sprue or a runner channel arranged in the injection molding tool and a second end forming a most constricted gate opening into the mold cavity. In this relation the mold may constitute a complete mold part or a mold insert adapted for insertion into a socket in an injection-molding tool.

### BACKGROUND

Traditionally this type of mold is used for rapid and easy injection molding of relatively small volumes of plastic products (e.g. prototypes), but throughout previous years, it has become increasingly attractive to use these molds for production of larger volumes.

For this purpose, in order to provide increased resistance of the mold insert against, for example, abrasion caused during production, various different embodiments of molds inserts have been proposed, e.g. from U.S. Pat. No. 9,902,108, where the inserts are cast molded from a plastic material with added fillers.

In this relation the gates are provided with standardized (off the shelf) metal bushings forming the injection gate leading from the runner channels in the molding tool where the inserts are mounted, to the mold cavity formed in the mold insert.

### SUMMARY

It is the object of the present disclosure to provide a mold for injection molding of the above mentioned kind where the mold is easy to produce and simple in construct, while still providing the option of producing high volumes of product in the same mold insert.

This is achieved by using a mold having a main body, being made from a plastic material and a filler, which forms at least part of the gate and especially the second end of the gate. These molds, as described herein increase wear resistance of the main body.

In a further preferred embodiment, the main body forms the complete gate.

In order to further increase the wear resistance of the gate it may comprise a first funnel shaped section arranged upstream from the most constricted gate opening, and a second funnel shaped section arranged between the most constricted gate opening and the first funnel shaped section, and where the included angle between two opposite sides of the first funnel shaped section is larger than the included angle between two corresponding sides of the second funnel shaped section.

Furthermore the gate may advantageously comprise a third section forming the most constricted gate opening into the mold cavity, the third section being either cylinder shaped or funnel shaped, and where the included angle between two opposite sides of the second funnel shaped section is larger than the included angle between two corresponding sides of the third funnel shaped section.

In an especially advantageous embodiment, the included angle between the two opposite sides of the first funnel shaped section is larger than 60 degrees and the included angle between two corresponding sides of the second funnel shaped section is smaller than 45 degrees and larger than 20 degrees.

Furthermore, each of the fist and the second funnel shaped sections may advantageously form a cone frustum.

The gate may further have a transitional funnel shaped section that is arranged between the first and the second funnel shaped sections the transitional funnel shaped section funning part of a ring torus providing a smooth transition between the first and the second funnel shaped sections.

The filler material may advantageously comprise a ceramic material, but it might alternatively comprise a fiber material.

The disclosure also relates to a method for producing a mold as mentioned above, where the mold is advantageously produced by stereolithographic printing using a material comprising a photopolymerizable resin.

It should be appreciated that the subject technology can be implemented and utilized in numerous ways, including without limitation as a process, an apparatus, a system, a device, a method for applications now known and later developed or a computer readable medium. These, and other unique features of the system disclosed herein will become more readily apparent from the following description and the accompanying drawings.

### BRIEF DESCRIPTION OF THE DRAWINGS

So that those having ordinary skill in the art to which the disclosed technology appertains will more readily understand how to make and use the same, reference may be had to the following drawings.

FIG. 1 is a cross sectional view showing the construction of a PRIOR ART embodiment of a mold insert.

FIG. 2 is a cross sectional view showing the construction of one embodiment of a mold according to the subject technology.

FIG. 3 is an enlarged cross sectional view showing section A of the mold of FIG. 2.

FIG. 4 is a cross sectional view showing the construction of an second embodiment of a mold according to the subject technology.

FIG. 5 is an enlarged cross sectional view showing section B of the mold shown in FIG. 4.

### DETAILED DESCRIPTION

The subject technology overcomes many of the prior art problems associated with molds and mold inserts. The advantages and other features of the technology disclosed herein, will become more readily apparent to those having ordinary skill in the art from the following detailed description of certain preferred embodiments taken in conjunction with the drawings which set forth representative embodiments of the present technology and wherein like reference numerals identify similar structural elements. Directional indications such as upward, downward, right, left and the like are used with respect to the figures and not meant in a limiting manner.

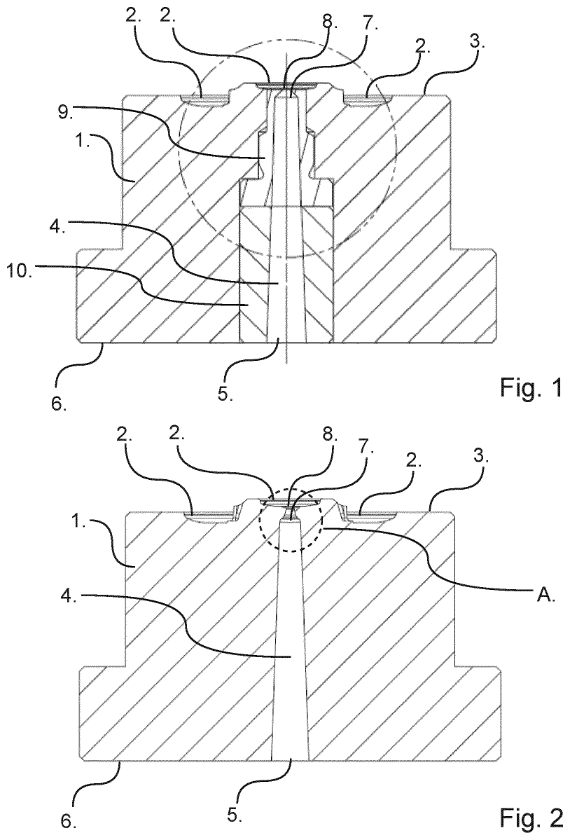

FIG. 1 shows an embodiment of a mold insert for injection molding according to the prior art. The mold insert has a main body 1 being adapted for being mounted into an injection molding tool, such as a mold plate (not shown). The construction of injection molding tolls are well known to the skilled person then these tools are not shown in the drawings.

The main body 1 is made in a layer by layer manner via additive manufacturing. Such additive manufacturing techniques may include stereolithographic printing which utilizes a material comprising a photopolymerizable resin with a filler material such as a ceramic material.

The main body has a mold cavity 2 arranged at one side 3 of the main body 1, coinciding with a separation plane of the injection molding tool. The main body 1 also has a pin gate 4 for injection running along the per se separation plane of the main body, and thus further arranged in the mold insert. The pin gate 4 in this embodiment forms a straight channel having a first end 5 arranged at art opposite side 6 of the main body and coinciding with a second separation plane of the molding tool. As it is well known in prior art this first end 5 of the pin gate 4 is connected to a runner channel (not shown) in the injection molding tool.

The pin gate 4 has a second end forming a most constricted gate opening 8 into the mold cavity 2 so that liquefied plastic material from the runner channel can be injected through the pin gate 4 into the mold cavity 2 via the most constricted gate opening 8. Thereafter, a solidified plastic material formed in the mold cavity 2 can be ejected from the mold cavity 2, and the solidified plastic material in the pin gate 4 can simultaneously be ejected when the injection mold is opened.

As it is exemplified in the prior art, the pin gate 4 is formed by metal bushings 9, 10 such as steel or brass bushings.

FIG. 2 shows a mold insert according to one embodiment of the present disclosure having similar outer dimensions as the prior art mold insert shown in FIG. 1, and having a mold cavity 2 and a pin gate 4 adapted so that it can produce the same product as the prior art mold insert. Thereby the mold insert shown in FIG. 2 may advantageously replace the prior art mold insert shown in FIG. 1 without any changes to the injection molding tool. The corresponding reference numerals shown in FIG. 2 therefore represent the same elements as the ones shown in FIG. 1 for the sake of simplicity.

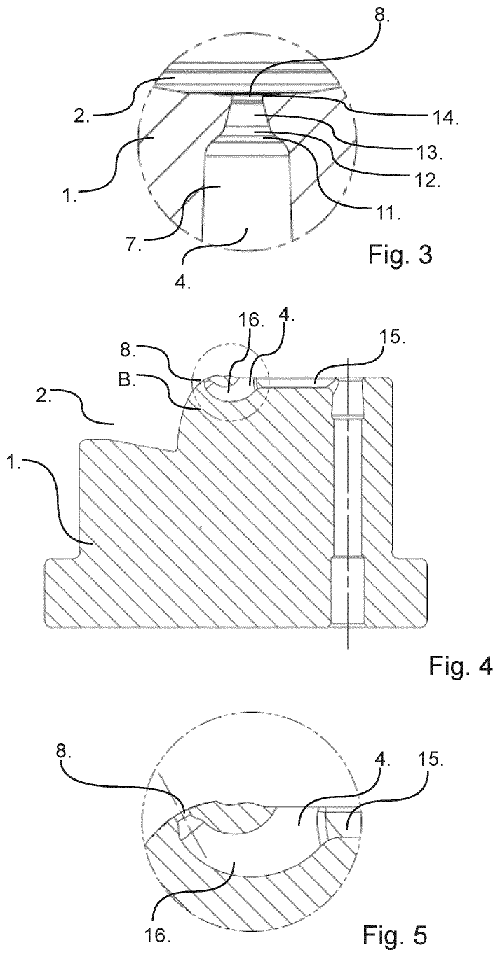

FIG. 2 differs from the prior art, however, because the main body 1 of the present disclosure forms the pin gate 4 and the most constricted gate opening 8, as described in further detail with reference to FIG. 3.

FIG. 3 shows an enlarged vie of section A depicted in FIG. 2. According to the embodiment, the pin gate 4 tapers to the most constricted gate opening 8. In this regard, the second end 7 of the pin gate 4 has a first funnel shaped section 11, a transitional funnel shaped section 12, a second funnel shaped section 13 and a third section 14 lead to the most constricted gate opening 8.

The sidewall of the first funnel shaped section 11 diverges more than the corresponding sidewall of the second funnel shaped section 13, which diverges more than the corresponding sidewall of the third section 14, the likes of which are almost or completely cylindrical and nondiverging. The tapering of the pin gate 4 to the most constricted gate opening 8 is further achieved because the transitional funnel section 12 between the first 11, and the second 13 funnel shaped sections is shaped as a torus, so that it provides a smooth transition between funnel sections 11 and 13. Each of these features provides that the second end of the pin gate 4 is made more resistant against wearing.

In FIGS. 2 and 3 the present disclosure is explained with reference to an embodiment with a pin gate 4, but it will be apparent to the one having ordinary skill in the art that the present disclosure may be implemented in many different embodiments apart from the embodiment shown in these figures.

As mentioned above the principle of the disclosure may also be used in relation to mold inserts having different types and shapes of the gates such as shown in FIGS. 4 and 5 showing a mold insert having a tunnel gate or more specifically a banana gate 15. In this embodiment, the main body 1 also forms a runner channel 15 being connected to the first end 4 of the banana gate.

It will be appreciated by those of ordinary skill in the pertinent art that the functions of several elements may, in alternative embodiments, be carried out by fewer elements, or a single element. Similarly, in some embodiments, any functional element may perform fewer, or different, operations than those described with respect to the illustrated embodiment. Also, functional elements shown as distinct for purposes of illustration may be incorporated within other functional elements in a particular implementation.

While the subject technology has been described with respect to preferred embodiments, those skilled in the art will readily appreciate that various changes and/or modifications can be made to the subject technology without departing from the spirit or scope of the subject technology as exemplified by the appended claims.

1. A mold adapted for an injection-molding tool, the mold having:
a main body made from a material comprising a plastic material and filler material, the main body having one side forming a mold cavity; and
a gate having a first end with an opening arranged for being connected to a sprue or a runner channel arranged in the injection molding tool, and a second end forming a most constricted gate opening into the mold cavity,
wherein the main body forms at least the second end of the gate.

2. A mold according to claim 1, wherein the main body forms the complete gate.

3. A mold according to claim 1, wherein:
the gate has a first funnel shaped section arranged upstream from the most constricted gate opening, and a second funnel shaped section arranged between the most constricted gate opening and the first funnel shaped section, and
an angle between two opposite sides of the first funnel shaped section is larger than an angle between two corresponding sides of the second funnel shaped section.

4. A mold according to claim 3, wherein:
the gate has a third section forming the most constricted gate opening into the mold cavity, the third section being either cylinder shaped or funnel shaped, and
an angle between two opposite sides of the second funnel shaped section is larger than an angle between two corresponding sides of the third funnel shaped section.

5. A mold according to claim 3, wherein:
the angle between the two opposite sides of the first funnel shaped section is larger than 60 degrees, and
the angle between two corresponding sides of the second funnel shaped section is smaller than 45 degrees and larger than 20 degrees.

6. A mold according to claim 3, wherein each of the first and the second funnel shaped sections forms a cone frustum.

7. A mold according to claim 6, wherein a transitional funnel shaped section is arranged between the first and the second funnel shaped sections, the transitional funnel shaped section forming part of a ring torus providing a smooth transition between the first and the second funnel shaped sections.

8. A mold according to claim 1, wherein the main body also comprises a ceramic filler material added to the plastic material.

9. (canceled)

10. (canceled)

11. A mold for an injection molding tool comprising:
a pin gate extending between a gate inlet and a gate opening, the pin gate forming a tapered, cylindrical channel through a body of the mold and abruptly transitioning to a smooth funnel, the gate opening positioned at an end of the funnel, the pin gate configured to receive molding material from a runner channel of the injection molding tool at the gate inlet and dispense the molding material at the gate opening; and
a mold cavity in fluid connection with the gate opening of the pin gate and configured to receive the molding material therefrom.

12. A mold according to claim 11, wherein the funnel is formed by:
a first funnel shaped section which is upstream of a transitional funnel shaped section, the transitional funnel shaped section upstream of a second funnel shaped section, the second funnel shaped section upstream of a third section, the third section terminating in the gate opening, the first, transitional, second funnel shaped sections, and the third section in fluid communication with each other.

13. A mold according to claim 12, wherein the first, transitional, and second funnel shaped section are frustoconical in shape such that each section is defined by a truncated tip and a base, the truncated tip of each respective section positioned downstream of the base of each respective section.

14. A mold according to claim 11, wherein the funnel has concave, inward shaped sidewalls.

15. A mold according to claim 11, wherein the funnel is integrally formed with the mold cavity.

16. A mold according to claim 11, wherein the funnel is made of plastic.

17. A mold for an injection molding tool comprising:
a mold body defining an interior channel cavity for transporting molding material, the interior channel defining a tapering sidewall, the interior channel further defining a smooth nozzle downstream of the tapering sidewall; and
a mold cavity defined by an exterior of the mold body,
wherein the nozzle is configured to dispense the molding material into the mold cavity.

18. A mold according to claim 17, wherein the nozzle is formed by:
a first funnel shaped section which is upstream of a transitional funnel shaped section, the transitional funnel shaped section upstream of a second funnel shaped section, the second funnel shaped section upstream of a third section, the third section terminating in the gate opening, the first, transitional, second funnel shaped sections, and the third section in fluid communication with each other.

19. A mold according to claim 18, wherein the first, transitional, and second funnel shaped section are frustoconical in shape such that each section is defined by a truncated tip and a base, the truncated tip of each respective section positioned downstream of the base of each respective section.

20. A mold according to claim 17, wherein the nozzle has concave, inward shaped sidewalls.

21. A mold according to claim 17, wherein the nozzle is integrally formed with the mold cavity.

22. A mold according to claim 17, wherein the nozzle is made of plastic.
